(19) United States
(12) Patent Application Publication
(10) Pub. No.: US 2005/0219724 A1
(43) Pub. Date: Oct. 6, 2005

(54) Optical element having a dielectric multilayer film

(75) Inventors: Miyuki Teramoto, Osaka (JP); Masaaki Nose, Osaka (JP)

Correspondence Address: BRINKS HOFER GILSON & LIONE, P.O. BOX 10395, CHICAGO, IL, 60610, US

(73) Assignee: Konica Minolta Opto, Inc.

(21) Appl. No.: 11/094,465

(22) Filed: Mar. 30, 2005

(30) Foreign Application Priority Data
Mar. 31, 2004 (JP) 2004-107439

(51) Int. Cl. G02B 1/10; G02B 5/08; G02B 7/182

(52) U.S. Cl. 359/883

(57) ABSTRACT

In an optical element having an optical substrate and a laminate having high-refractive-index and low-refractive-index layers laid on top of one another, the low-refractive-index layers are formed of a mixture of Al₂O₃ and SiO₂. Alternatively, in an optical element having an optical substrate and a laminate having high-refractive-index and low-refractive-index layers laid on top of one another, the low-refractive-index layers are formed of a mixture of SiO₂ and a material having a refractive index approximately equal to the refractive index of SiO₂ and having a property of mitigating compression stresses in SiO₂, and the high-refractive-index layers are formed of a material based on titanium oxide.

This application is based on Japanese Patent Application No. 2004-107439 filed on Mar. 31, 2004, the contents of which are hereby incorporated by reference.

### BACKGROUND OF THE INVENTION

1. Field of the Invention

The present invention relates to an optical element having a dielectric multilayer film, and more particularly to an optical element having a dielectric multilayer film such as an anti-reflection film or infrared cut filter film.

2. Description of Related Art

There have conventionally been proposed various types of optical element (lenses and filters) made of synthetic resin and having a dielectric multilayer film (for example, see Patent Publications 1 to 4 listed below). In these optical elements, the dielectric multilayer film has high-refractive-index layers and low-refractive-index layers laid alternately on top of one another, and is designed to offer high heat resistance, high abrasion resistance, and other desirable properties.
Patent Publication 1: Japanese Examined Patent Application Published No. H7-119844
Patent Publication 2: Japanese Examined Patent Application Published No. H7-119845
Patent Publication 3: Japanese Examined Patent Application Published No. H6-85001
Patent Publication 4: Japanese Patent Registered No. 3068252

In general, when a dielectric multilayer film is formed on a glass substrate, film formation is performed with the substrate heated to a temperature of 200° C. or higher. On the other hand, when a dielectric multilayer film is formed on a synthetic resin substrate, since the substrate itself has low heat resistance, it can hardly be heated. As a result, disadvantageously, a dielectric multilayer film formed on a synthetic resin substrate exhibits weaker adherence to the substrate than one formed on a glass substrate, and is accordingly less durable. Moreover, since synthetic resin has a higher heat expansion coefficient than glass and than materials for a thin film, disadvantageously, the larger the number of layers a dielectric multilayer film formed on a synthetic resin substrate has, the more intense the stresses it suffers, resulting in exfoliation or cracks.

Moreover, when a dielectric multilayer film is formed on a synthetic resin substrate, typically used as a low-refractive-index material is SiO₂, which has the disadvantage of developing intense compression stresses. When this material is used in combination with a high-refractive-index material based on titanium oxide, which develops tension stresses, since the stresses of the two materials act in opposite directions, the overall stresses tend to be mitigated. However, when SiO₂ and a high-refractive-index material are laid alternately with equal optical film thicknesses (=n·d, where n represents the refractive index and d represents the film thickness), since the SiO₂ layers with a lower refractive index have a greater physical thickness, compression stresses tend to increase, and this tendency becomes more noticeable the larger the number of layers. As a result, even when no defects are found immediately after film formation, a dielectric multilayer film may develop exfoliation or cracks while it is simply set aside in the atmosphere.

### SUMMARY OF THE INVENTION

In view of the conventionally encountered disadvantages discussed above, it is an object of the present invention to provide an optical element having a dielectric multilayer film that offers excellent optical properties in combination with high reliability.

To achieve the above object, in one aspect of the present invention, in an optical element provided with an optical substrate and a laminate having high-refractive-index and low-refractive-index layers laid on top of one another, the low-refractive-index layers are formed of a mixture of Al₂O₃ and SiO₂.

In another aspect of the present invention, in an optical element provided with an optical substrate and a laminate having high-refractive-index and low-refractive-index layers laid on top of one another, the low-refractive-index layers are formed of a mixture of SiO₂ and a material having a refractive index approximately equal to the refractive index of SiO₂ and having a property of mitigating compression stresses in SiO₂, and the high-refractive-index layers are formed of a material based on titanium oxide.

According to the present invention, low-refractive-index layers are formed of a mixture of Al₂O₃ and SiO₂. This helps mitigate stresses without degrading optical properties, and thus helps prevent development of exfoliation and cracks. Thus, it is possible to realize an optical element having a dielectric multilayer film that offers excellent optical properties in combination with high reliability.

### BRIEF DESCRIPTION OF THE DRAWINGS

FIGS. 1A and 1B are sectional views schematically showing the layer structures of dielectric multilayer films according to the invention.

### DETAILED DESCRIPTION OF PREFERRED EMBODIMENTS

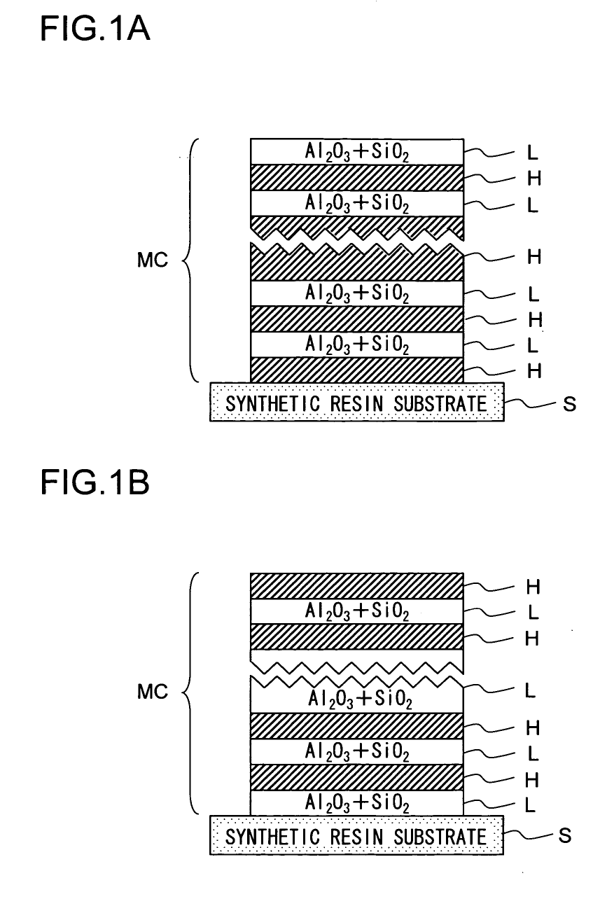

Hereinafter, optical elements embodying the present invention will be described with reference to the drawings. FIGS. 1A and 1B schematically show, in an optical section, the layer structures of dielectric multilayer films MC formed in optical elements embodying the invention. The optical elements shown in FIGS. 1A and 1B both have high-refractive-index layers H and low-refractive-index layers L formed alternately on top of one another on top of a synthetic resin substrate S. FIG. 1A shows the type in which the layer that lies in contact with the synthetic resin substrate S is a high-refractive-index layer H, and FIG. 1B shows the type in which the layer that lies in contact with the synthetic resin substrate S is a low-refractive-index layer L.

The synthetic resin substrate S corresponds to an optical element formed of synthetic resin, such as a plastic lens element or plastic flat plate. The synthetic resin substrate S is formed of, for example, cycloolefin resin such as ZEONEX (product name) or APEL (product name), acrylic resin such as PMMA (polymethyl methacrylate), or PC (polycarbonate). The low-refractive-index layers L are formed of a mixture of Al₂O₃ (aluminum oxide) and SiO₂ (silicon dioxide). The high-refractive-index layers H are formed of a material based on TiO₂, for example, titanium oxide (with Ti₂O₃, Ti₃O₅, etc. used as a vapor-deposited material), a mixture of titanium oxide and tantalum oxide (TiO₂+Ta₂O₅, etc.), a mixture of titanium oxide and lanthanum oxide (TiO₂+La₂O₃, etc.), a mixture of titanium oxide and zirconium oxide (TiO₂+ZrO₂, etc.), a mixture of titanium oxide and dysprosium oxide (TiO₂+Dy₂O₅, etc.). For example, the high-refractive-index layers H have a refractive index of 1.8 or higher, and the low-refractive-index layers L have a refractive index of 1.4 or higher but lower than 1.8. Preferably, the high-refractive-index layers H have a refractive index of 1.9 or higher, and the low-refractive-index layers L have a refractive index lower than 1.5.

As described earlier, when a dielectric multilayer film such as an anti-reflection film or filter film is formed by laying an optical thin film on top of a synthetic resin substrate, since the synthetic resin substrate does not withstand being heated to a high temperature (a glass substrate is typically heated to 200° C. to 300° C.), it needs to be either heated to a low temperature below 100° C. or not heated at all. Thus, so long as common materials for a thin film are used, it is impossible to obtain an optical thin film having satisfactory durability and satisfactory adherence to the substrate. In particular, SiO₂, a common low-refractive-index material, forms an optical thin film that develops intense stresses, the larger the number of layers a dielectric multilayer film has, the more likely an imbalance of stresses between the low-refractive-index and high-refractive-index layers, leading to development of exfoliation or cracks. In addition, since synthetic resin has a high thermal expansion coefficient, the more layers a dielectric multilayer film has, the more intense stresses it suffers, causing exfoliation or cracks.

To overcome the problems mentioned above, in the embodiment under discussion, the low-refractive-index layers L are formed of a mixture of Al₂O₃ and SiO₂. Using a mixture of Al₂O₃ and SiO₂ to form the low-refractive-index layers L, as compared with using SiO₂, helps reduce the stresses that develop in the low-refractive-index layers L. In particular, using a material containing titanium oxide to form the high-refractive-index layers H helps deliver a proper balance of stresses between the low-refractive-index layers L and the high-refractive-index layers H so as to cancel them out. In this way, it is possible to enhance the durability of the dielectric multilayer film MC and prevent development of exfoliation and cracks. Moreover, since a mixture of Al₂O₃ and SiO₂ has a refractive index approximately equal to that of SiO₂ (while SiO₂ has a refractive index of about 1.46, Al₂O₃+SiO₂ has a refractive index of about 1.47), using the former does not degrade optical properties. Thus, it is possible to obtain, even on top of a synthetic resin substrate S, a dielectric multilayer film MC that offers excellent optical properties in combination with high reliability.

The larger the number of layers a dielectric multilayer film has, the better its optical properties, but simultaneously the more likely development of exfoliation or cracks. Thus, a structure that uses a mixture of Al₂O₃ and SiO₂ to mitigate stresses in the low-refractive-index layers L is particularly effective in forming a dielectric multilayer film MC having a large number of layers. In general, when there are four or more layers, they tend to be affected greatly by stresses. Thus, such a dielectric multilayer film MC is suitable for a layer structure including four or more layers. For example, to form an anti-reflection film, it is preferable that a dielectric multilayer film MC be given a layer structure including six to ten layers. On the other hand, to form an optical element that functions as an infrared cut filter, since such an optical element typically requires 30 or more layers, it is preferable that a dielectric multilayer film MC be given a layer structure including 30 or more layers.

It is preferable that the high-refractive-index layers H be formed of titanium oxide, or a mixture of titanium oxide with tantalum oxide, lanthanum oxide, zirconium oxide, or dysprosium oxide. This helps deliver a more proper balance of stresses between the low-refractive-index layers L and the high-refractive-index layers H so as to cancel them out. Titanium oxide or a mixture containing it is suitable as a material that permits easy cancellation of stresses, and in addition its high refractive index makes its use advantageous in terms of optical properties. It is preferable that the layer that lies in contact with the synthetic resin substrate S be a high-refractive-index layer H. Given the refractive index of a common synthetic resin substrate S, laying a high-refractive-index layer H as the one that lies in contact with the synthetic resin substrate S as shown in FIG. 1A contributes to the enhancement to f the optical properties needed in a dielectric multilayer film MC. It is preferable that, of all the low-refractive-index layers L included in a dielectric multilayer film MC, the thickest one be laid second or later as counted from the substrate side. Moreover, it is preferable that the total thickness of the mixture of Al₂O₃ and SiO₂ be 53% or more of the total thickness of the entire dielectric multilayer film MC.

### EXAMPLES

Hereinafter, numerical examples of optical elements embodying the invention will be presented with reference to the optical structures and other features of the dielectric multilayer films MC formed therein. Tables 1 to 16 show the optical structures of Examples 1 to 10 and Comparative Examples 1 to 6, respectively. In these tables, λ represents the design reference wavelength, n represents the refractive index at the design reference wavelength λ, and d represents the film thickness in nm. Examples 1 to 7, 9, and 10 and Comparative Examples 1 to 3, 5, and 6 each function as an anti-reflection film, and Example 8 and Comparative Example 4 each function as an infrared cut filter. In all these examples and comparative examples, the dielectric multilayer film was formed by vapor deposition, without the substrate heated. It should be understood, however, that dielectric multilayer films embodying the invention may be formed by any method other than vapor deposition, for example by sputtering, ion plating, etc.

With each of the dielectric multilayer films of Examples 1 to 10 and Comparative Examples 1 to 6, durability tests were conducted in the following manner:

(a) Storage in a High-Temperature, High-Humidity Environment

The optical elements were kept for 168 hours in a temperature- and humidity-controlled chamber set at a temperature of 70° C. and a humidity of 80%. Thereafter, the optical elements were visually inspected for cracks or exfoliation.

(b) Irradiation with Ultraviolet Light

The optical elements were irradiated for 48 hours with ultraviolet light at a rate of 15 mW/cm². Thereafter, the optical elements were visually inspected for cracks or exfoliation.

(c) Exposure to Temperature Shock

The optical elements were kept at a temperature of −30° C. for one hour and were then kept at 70° C. for one hour. This two-hour cycle was repeated ten times, and then the optical elements were visually inspected for cracks or exfoliation.

(d) Storage in a Low-Temperature Environment

The optical elements were kept for 168 hours in a temperature-controlled chamber set at a temperature of −30° C. Thereafter, the optical elements were visually inspected for cracks or exfoliation.

Table 17 shows the results of the above durability tests conducted with the dielectric multilayer films of Examples 1 to 10 and Comparative Examples 1 to 6. In this table, “OK” indicates that no change was recognized, and “NG” indicates that cracks or exfoliation was recognized. As will be understood from Table 17, the optical elements of Examples 1 to 10 exhibit higher durability, in particular against ultraviolet light irradiation and temperature shock, than those of Comparative Examples 1 to 6.

In Examples 1 to 10 and Comparative Examples 1 to 6, the different layers of the respective dielectric multilayer films MC were formed under the following conditions:

### (I) Examples 1 to 7, 9, and 10 and Comparative Examples 1 to 3, 5, and 6

(i) Vapor-Deposition Conditions for Al₂O₃+SiO₂ and for SiO₂

| | |
|---|---|
| Degree of vacuum: | 3.0 × 10⁻³ Pa |
| Oxygen Introduction: | 1.3 × 10⁻² Pa |
| EB Current: | 100 mA |

(ii) Vapor-Deposition Conditions for TiO₂+Ta₂O₅

| | |
|---|---|
| Degree of vacuum: | 3.0 × 10⁻³ Pa |
| Oxygen Introduction: | 2.0 × 10⁻² Pa |
| EB Current: | 280 mA |

(iii) Vapor-Deposition Conditions for TiO₂+La₂O₃

| | |
|---|---|
| Degree of vacuum: | 3.0 × 10⁻³ Pa |
| Oxygen Introduction: | 2.0 × 10⁻² Pa |
| EB Current: | 165 mA |

(iv) Vapor-Deposition Conditions for TiO₂+Dy₂O₃

| | |
|---|---|
| Degree of vacuum: | 3.0 × 10⁻³ Pa |
| Oxygen Introduction: | 2.0 × 10⁻² Pa |
| EB Current: | 200 mA |

(v) Vapor-Deposition Conditions for TiO₂+ZrO₂

| | |
|---|---|
| Degree of vacuum: | 3.0 × 10⁻³ Pa |
| Oxygen Introduction: | 2.0 × 10⁻² Pa |
| EB Current: | 170 mA |

### (II) Example 8 and Comparative Example 4

(i) Vapor-Deposition Conditions for Al₂O₃+SiO₂ and for SiO₂

| | |
|---|---|
| Degree of vacuum: | 2.0 × 10⁻³ Pa |
| Oxygen Introduction: | No |
| EB Current: | 40 mA |

(ii) Vapor-Deposition Conditions for TiO₂

| | |
|---|---|
| Degree of vacuum: | 2.0 × 10⁻³ Pa |
| Oxygen Introduction: | 1.2 × 10⁻² Pa |
| EB Current: | 230 mA |

Table 18 shows, for each of Examples 1 to 10, the ratio of the total thickness of the mixture of Al₂O₃ and SiO₂ to the total thickness of the entire dielectric multilayer film MC, along with the position of the low-refractive-index layer having the greatest thickness d as counted from the substrate side.

TABLE 1
Example 1

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 10 | SiO2 + Al2O3 | 1.475 | 93.12 | 0.999 |
| 9 | TiO2 + Ta2O5 | 1.949 | 29.55 | 0.419 |
| 8 | SiO2 + Al2O3 | 1.475 | 20.54 | 0.220 |
| 7 | TiO2 + Ta2O5 | 1.949 | 79.5 | 1.127 |
| 6 | SiO2 + Al2O3 | 1.475 | 159.08 | 1.706 |
| 5 | TiO2 + Ta2O5 | 1.949 | 15 | 0.213 |
| 4 | SiO2 + Al2O3 | 1.475 | 62.58 | 0.671 |
| 3 | TiO2 + Ta2O5 | 1.949 | 28.52 | 0.404 |
| 2 | SiO2 + Al2O3 | 1.475 | 28.08 | 0.301 |
| 1 | TiO2 + Ta2O5 | 1.949 | 27.11 | 0.384 |
| Substrate | ZEONEX | | | |

TABLE 2
Example 2

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 8 | SiO2 + Al2O3 | 1.475 | 85.53 | 0.918 |
| 7 | TiO2 + Ta2O5 | 1.949 | 127.92 | 1.813 |
| 6 | SiO2 + Al2O3 | 1.475 | 78.33 | 0.840 |
| 5 | TiO2 + Ta2O5 | 1.949 | 14.77 | 0.209 |
| 4 | SiO2 + Al2O3 | 1.475 | 68.87 | 0.739 |
| 3 | TiO2 + Ta2O5 | 1.949 | 21.81 | 0.309 |
| 2 | SiO2 + Al2O3 | 1.475 | 62.92 | 0.675 |
| 1 | TiO2 + Ta2O5 | 1.949 | 14.77 | 0.209 |
| Substrate | ZEONEX | | | |

TABLE 3
Example 3

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 6 | SiO2 + Al2O3 | 1.475 | 76.97 | 0.826 |
| 5 | TiO2 + Ta2O5 | 1.949 | 136.68 | 1.937 |
| 4 | SiO2 + Al2O3 | 1.475 | 54.1 | 0.580 |
| 3 | TiO2 + Ta2O5 | 1.949 | 15 | 0.213 |
| 2 | SiO2 + Al2O3 | 1.475 | 64.28 | 0.690 |
| 1 | TiO2 + Ta2O5 | 1.949 | 15.69 | 0.222 |
| Substrate | ZEONEX | | | |

TABLE 4
Example 4

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 10 | SiO2 + Al2O3 | 1.475 | 93.12 | 0.999 |
| 9 | TiO2 + La2O3 | 1.9 | 30.31 | 0.419 |
| 8 | SiO2 + Al2O3 | 1.475 | 20.54 | 0.220 |
| 7 | TiO2 + La2O3 | 1.9 | 81.55 | 1.127 |
| 6 | SiO2 + Al2O3 | 1.475 | 159.08 | 1.706 |
| 5 | TiO2 + La2O3 | 1.9 | 15.39 | 0.213 |
| 4 | SiO2 + Al2O3 | 1.475 | 62.58 | 0.671 |
| 3 | TiO2 + La2O3 | 1.9 | 29.26 | 0.404 |
| 2 | SiO2 + Al2O3 | 1.475 | 28.08 | 0.301 |
| 1 | TiO2 + La2O3 | 1.9 | 27.81 | 0.384 |
| Substrate | ZEONEX | | | |

TABLE 5
Example 5

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 8 | SiO2 + Al2O3 | 1.475 | 85.53 | 0.918 |
| 7 | TiO2 + Dy2O3 | 1.98 | 125.92 | 1.813 |
| 6 | SiO2 + Al2O3 | 1.475 | 78.33 | 0.840 |
| 5 | TiO2 + Dy2O3 | 1.98 | 14.54 | 0.209 |
| 4 | SiO2 + Al2O3 | 1.475 | 68.87 | 0.739 |
| 3 | TiO2 + Dy2O3 | 1.98 | 21.47 | 0.309 |
| 2 | SiO2 + Al2O3 | 1.475 | 62.92 | 0.675 |
| 1 | TiO2 + Dy2O3 | 1.98 | 14.54 | 0.209 |
| Substrate | ZEONEX | | | |

TABLE 6
Example 6

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 6 | SiO2 + Al2O3 | 1.475 | 76.97 | 0.826 |
| 5 | TiO2 + ZrO2 | 1.94 | 137.31 | 1.937 |
| 4 | SiO2 + Al2O3 | 1.475 | 54.10 | 0.580 |
| 3 | TiO2 + ZrO2 | 1.94 | 15.07 | 0.213 |
| 2 | SiO2 + Al2O3 | 1.475 | 64.28 | 0.690 |
| 1 | TiO2 + ZrO2 | 1.94 | 15.76 | 0.222 |
| Substrate | ZEONEX | | | |

TABLE 7
Example 7

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 8 | SiO2 + Al2O3 | 1.475 | 85.53 | 0.918 |
| 7 | TiO2 | 2.09 | 119.29 | 1.813 |
| 6 | SiO2 + Al2O3 | 1.475 | 78.33 | 0.840 |
| 5 | TiO2 | 2.09 | 13.77 | 0.209 |
| 4 | SiO2 + Al2O3 | 1.475 | 68.87 | 0.739 |
| 3 | TiO2 | 2.09 | 20.34 | 0.309 |
| 2 | SiO2 + Al2O3 | 1.475 | 62.92 | 0.675 |
| 1 | TiO2 | 2.09 | 13.77 | 0.209 |
| Substrate | ZEONEX | | | |

TABLE 8
Example 8

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 32 | SiO2 + Al2O3 | 1.47 | 107.76 | 1.152 |
| 31 | TiO2 | 2.09 | 111.14 | 1.689 |
| 30 | SiO2 + Al2O3 | 1.47 | 188.03 | 2.010 |
| 29 | TiO2 | 2.09 | 113.35 | 1.723 |
| 28 | SiO2 + Al2O3 | 1.47 | 152.94 | 1.635 |
| 27 | TiO2 | 2.09 | 117.14 | 1.781 |
| 26 | SiO2 + Al2O3 | 1.47 | 164.44 | 1.758 |
| 25 | TiO2 | 2.09 | 109.29 | 1.661 |
| 24 | SiO2 + Al2O3 | 1.47 | 165.56 | 1.770 |
| 23 | TiO2 | 2.09 | 116.58 | 1.772 |
| 22 | SiO2 + Al2O3 | 1.47 | 152.28 | 1.628 |
| 21 | TiO2 | 2.09 | 101.31 | 1.540 |
| 20 | SiO2 + Al2O3 | 1.47 | 149.87 | 1.602 |
| 19 | TiO2 | 2.09 | 113.18 | 1.720 |
| 18 | SiO2 + Al2O3 | 1.47 | 165.89 | 1.774 |
| 17 | TiO2 | 2.09 | 110.46 | 1.679 |
| 16 | SiO2 + Al2O3 | 1.47 | 150.88 | 1.613 |
| 15 | TiO2 | 2.09 | 100.45 | 1.527 |
| 14 | SiO2 + Al2O3 | 1.47 | 137.11 | 1.466 |
| 13 | TiO2 | 2.09 | 90.26 | 1.372 |
| 12 | SiO2 + Al2O3 | 1.47 | 128.3 | 1.372 |
| 11 | TiO2 | 2.09 | 86.29 | 1.312 |
| 10 | SiO2 + Al2O3 | 1.47 | 120.66 | 1.290 |
| 9 | TiO2 | 2.09 | 90.63 | 1.378 |
| 8 | SiO2 + Al2O3 | 1.47 | 106.06 | 1.134 |
| 7 | TiO2 | 2.09 | 102.51 | 1.558 |
| 6 | SiO2 + Al2O3 | 1.47 | 82.37 | 0.881 |
| 5 | TiO2 | 2.09 | 106.61 | 1.620 |
| 4 | SiO2 + Al2O3 | 1.47 | 97.07 | 1.038 |
| 3 | TiO2 | 2.09 | 99.92 | 1.519 |
| 2 | SiO2 + Al2O3 | 1.47 | 122.47 | 1.309 |
| 1 | TiO2 | 2.09 | 106.4 | 1.617 |
| Substrate | PC | | | |

TABLE 9
Example 9

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 5 | SiO2 + Al2O3 | 1.475 | 84.18 | 0.903 |
| 4 | TiO2 | 2.09 | 66.54 | 1.011 |
| 3 | SiO2 + Al2O3 | 1.475 | 19.86 | 0.213 |
| 2 | TiO2 | 2.09 | 26.18 | 0.398 |
| 1 | SiO2 + Al2O3 | 1.475 | 176.63 | 1.895 |
| Substrate | ZEONEX | | | |

TABLE 10
Example 10

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 5 | SiO2 + Al2O3 | 1.475 | 87.94 | 0.943 |
| 4 | TiO2 | 2.09 | 65.31 | 0.993 |
| 3 | SiO2 + Al2O3 | 1.475 | 23.84 | 0.256 |
| 2 | TiO2 | 2.09 | 30.62 | 0.465 |
| 1 | SiO2 + Al2O3 | 1.475 | 21.06 | 0.226 |
| Substrate | PC | | | |

TABLE 11
Comparative Example 1

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 10 | SiO2 | 1.46 | 94.08 | 0.999 |
| 9 | TiO2 + Ta2O5 | 1.949 | 29.55 | 0.419 |
| 8 | SiO2 | 1.46 | 20.75 | 0.220 |
| 7 | TiO2 + Ta2O5 | 1.949 | 79.50 | 1.127 |
| 6 | SiO2 | 1.46 | 160.71 | 1.706 |
| 5 | TiO2 + Ta2O5 | 1.949 | 15.00 | 0.213 |
| 4 | SiO2 | 1.46 | 63.22 | 0.671 |
| 3 | TiO2 + Ta2O5 | 1.949 | 28.52 | 0.404 |
| 2 | SiO2 | 1.46 | 28.37 | 0.301 |
| 1 | TiO2 + Ta2O5 | 1.949 | 27.11 | 0.384 |
| Substrate | ZEONEX | | | |

TABLE 12
Comparative Example 2

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 8 | SiO2 | 1.46 | 86.41 | 0.918 |
| 7 | TiO2 + Ta2O5 | 1.949 | 127.92 | 1.813 |
| 6 | SiO2 | 1.46 | 79.13 | 0.840 |
| 5 | TiO2 + Ta2O5 | 1.949 | 14.77 | 0.209 |
| 4 | SiO2 | 1.46 | 69.58 | 0.739 |
| 3 | TiO2 + Ta2O5 | 1.949 | 21.81 | 0.309 |
| 2 | SiO2 | 1.46 | 63.57 | 0.675 |
| 1 | TiO2 + Ta2O5 | 1.949 | 14.77 | 0.209 |
| Substrate | ZEONEX | | | |

TABLE 13
Comparative Example 3

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 6 | SiO2 | 1.46 | 77.76 | 0.826 |
| 5 | TiO2 + Ta2O5 | 1.949 | 136.68 | 1.937 |
| 4 | SiO2 | 1.46 | 54.66 | 0.580 |
| 3 | TiO2 + Ta2O5 | 1.949 | 15.00 | 0.213 |
| 2 | SiO2 | 1.46 | 64.94 | 0.690 |
| 1 | TiO2 + Ta2O5 | 1.949 | 15.69 | 0.222 |
| Substrate | ZEONEX | | | |

TABLE 14
Comparative Example 4

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 32 | SiO2 | 1.46 | 108.50 | 1.152 |
| 31 | TiO2 | 2.09 | 111.14 | 1.689 |
| 30 | SiO2 | 1.46 | 189.31 | 2.010 |
| 29 | TiO2 | 2.09 | 113.35 | 1.723 |
| 28 | SiO2 | 1.46 | 153.99 | 1.635 |
| 27 | TiO2 | 2.09 | 117.14 | 1.781 |
| 26 | SiO2 | 1.46 | 165.56 | 1.758 |
| 25 | TiO2 | 2.09 | 109.29 | 1.661 |
| 24 | SiO2 | 1.46 | 166.69 | 1.770 |
| 23 | TiO2 | 2.09 | 116.58 | 1.772 |
| 22 | SiO2 | 1.46 | 153.32 | 1.628 |
| 21 | TiO2 | 2.09 | 101.31 | 1.540 |
| 20 | SiO2 | 1.46 | 150.89 | 1.602 |
| 19 | TiO2 | 2.09 | 113.18 | 1.720 |
| 18 | SiO2 | 1.46 | 167.02 | 1.773 |
| 17 | TiO2 | 2.09 | 110.46 | 1.679 |
| 16 | SiO2 | 1.46 | 151.92 | 1.613 |
| 15 | TiO2 | 2.09 | 100.45 | 1.527 |
| 14 | SiO2 | 1.46 | 138.05 | 1.466 |
| 13 | TiO2 | 2.09 | 90.26 | 1.372 |
| 12 | SiO2 | 1.46 | 129.18 | 1.372 |
| 11 | TiO2 | 2.09 | 86.29 | 1.312 |
| 10 | SiO2 | 1.46 | 121.48 | 1.290 |
| 9 | TiO2 | 2.09 | 90.63 | 1.378 |
| 8 | SiO2 | 1.46 | 106.79 | 1.134 |
| 7 | TiO2 | 2.09 | 102.51 | 1.558 |
| 6 | SiO2 | 1.46 | 82.93 | 0.881 |
| 5 | TiO2 | 2.09 | 106.61 | 1.620 |
| 4 | SiO2 | 1.46 | 97.73 | 1.038 |
| 3 | TiO2 | 2.09 | 99.92 | 1.519 |
| 2 | SiO2 | 1.46 | 123.31 | 1.309 |
| 1 | TiO2 | 2.09 | 106.4 | 1.617 |
| Substrate | PC | | | |

TABLE 15
Comparative Example 5

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 5 | SiO2 | 1.46 | 85.05 | 0.903 |
| 4 | TiO2 | 2.09 | 66.54 | 1.011 |
| 3 | SiO2 | 1.46 | 20.06 | 0.213 |
| 2 | TiO2 | 2.09 | 26.18 | 0.398 |
| 1 | SiO2 | 1.46 | 178.44 | 1.895 |
| Substrate | ZEONEX | | | |

TABLE 16
Comparative Example 6

| | | Refractive | Film | Optical Film |
|---|---|---|---|---|
| Layer | | Index: n | Thickness: d | Thickness: |
| No. | Material | (λ = 550 nm) | (nm) | 4 · n · d/λ |
| 5 | SiO2 | 1.46 | 88.85 | 0.943 |
| 4 | TiO2 | 2.09 | 65.31 | 0.993 |
| 3 | SiO2 | 1.46 | 24.09 | 0.256 |
| 2 | TiO2 | 2.09 | 30.62 | 0.465 |
| 1 | SiO2 | 1.46 | 21.28 | 0.226 |
| Substrate | PC | | | |

TABLE 17

| | Test Item | | | |
|---|---|---|---|---|
| | High-Temperature | | | |
| | High-Humidity | Ultraviolet Light | Temperature | Low-Temperature |
| | Environment | Irradiation | Shock | Environment |
| | Test Conditions | | | |
| | | | 1 Hour Each | |
| | | 48 Hours | at −30° C. | |
| | 168 Hours | with UV | & at 70° C. × 10 | 168 Hours |
| | at 70° C., 80% | at 15 mW/cm² | Cycles | at −30° C. |
| Example 1 | OK | OK | OK | OK |
| Example 2 | OK | OK | OK | OK |
| Example 3 | OK | OK | OK | OK |
| Example 4 | OK | OK | OK | OK |
| Example 5 | OK | OK | OK | OK |
| Example 6 | OK | OK | OK | OK |
| Example 7 | OK | OK | OK | OK |
| Example 8 | OK | OK | OK | OK |
| Example 9 | OK | OK | OK | OK |
| Example 10 | OK | OK | OK | OK |
| Comparative | OK | NG | NG | OK |
| Example 1 | | | | |
| Comparative | OK | NG | NG | OK |
| Example 2 | | | | |
| Comparative | OK | NG | NG | OK |
| Example 3 | | | | |
| Comparative | OK | NG | NG | OK |
| Example 4 | | | | |
| Comparative | OK | NG | NG | OK |
| Example 5 | | | | |
| Comparative | OK | NG | NG | OK |
| Example 6 | | | | |

TABLE 18

| | Ratio of | Position of |
|---|---|---|
| | Al2O3 + SiO2 Mixture | Thickest Among All |
| | Total Thickness to | Low-Refractieve-Index |
| | Overall Thickness (%) | Layers |
| Example 1 | 66.9 | 3 |
| Example 2 | 62.3 | 4 |
| Example 3 | 53.9 | 3 |
| Example 4 | 66.3 | 3 |
| Example 5 | 62.2 | 4 |
| Example 6 | 53.7 | 3 |
| Example 7 | 63.9 | 4 |
| Example 8 | 56.7 | 15 |
| Example 9 | 75.2 | 1 |
| Example 10 | 58.1 | 3 |

1. An optical element comprising:
an optical substrate; and
a laminate having high-refractive-index and low-refractive-index layers laid on top of one another,
wherein the low-refractive-index layers are formed of a mixture of Al₂O₃ and SiO₂.

2. The optical element of claim 1, wherein the optical substrate is formed of resin.

3. The optical element of claim 1, wherein the optical substrate is transparent.

4. The optical element of claim 2, wherein the optical substrate is formed of cycloolefin resin.

5. The optical element of claim 1, wherein each layer is formed of a dielectric material.

6. The optical element of claim 1, wherein the high-refractive-index layers have a refractive index of 1.8 or more and the low-refractive-index layers have a refractive index less than 1.8.

7. The optical element of claim 6, wherein the high-refractive-index layers have a refractive index of 1.9 or more and the low-refractive-index layers have a refractive index less than 1.5.

8. The optical element of claim 1, wherein the high-refractive-index layers are formed of one of the following five materials: titanium oxide, a mixture of titanium oxide and tantalum oxide, a mixture of titanium oxide and lanthanum oxide, a mixture of titanium oxide and zirconium oxide, and a mixture of titanium oxide and dysprosium oxide.

9. The optical element of claim 1, wherein a layer that lies in contact with the optical substrate is a high-refractive-index layer.

10. The optical element of claim 1, wherein a total thickness of the mixture of Al₂O₃ and SiO₂ is 53% or more of a total thickness of the entire laminate.

11. The optical element of claim 1, wherein the optical substrate is formed of transparent resin and wherein a layer that lies in contact with the optical substrate is a high-refractive-index layer.

12. The optical element of claim 1, wherein the laminate includes four or more layers.

13. The optical element of claim 12, wherein a thickest low-refractive-index layer lies second or later as counted from an optical substrate side.

14. The optical element of claim 1, wherein the laminate includes 30 or more layers and functions as an infrared cut filter.

15. The optical element of claim 1, wherein the laminate includes six to ten layers and has an anti-reflection property.

16. An optical element comprising:
an optical substrate; and
a laminate having high-refractive-index and low-refractive-index layers laid on top of one another,
wherein the low-refractive-index layers are formed of a mixture of SiO₂ and a material having a refractive index approximately equal to a refractive index of SiO₂ and having a property of mitigating compression stresses in SiO₂, and
wherein the high-refractive-index layers are formed of a material based on titanium oxide.

17. The optical element of claim 16, wherein the optical substrate is formed of resin.

18. The optical element of claim 16, wherein the high-refractive-index layers are formed of one of the following five materials: titanium oxide, a mixture of titanium oxide and tantalum oxide, a mixture of titanium oxide and lanthanum oxide, a mixture of titanium oxide and zirconium oxide, and a mixture of titanium oxide and dysprosium oxide.

19. The optical element of claim 16, wherein a layer that lies in contact with the optical substrate is a high-refractive-index layer.

20. The optical element of claim 16, wherein the low-refractive-index layers are formed of a mixture of Al₂O₃ and SiO₂.
